(19) United States
(12) Patent Application Publication
(10) Pub. No.: US 2011/0192345 A1
(43) Pub. Date: Aug. 11, 2011

(54) SPONGE STAMPS, STAMP PAD, AND STAMP PAD SET

(76) Inventor: Rira Yasoshima, Tokyo (JP)

(21) Appl. No.: 13/008,741

(22) Filed: Jan. 18, 2011

(30) Foreign Application Priority Data
Jan. 18, 2010 (JP) 2010008507

(51) Int. Cl. B05C 1/00; C08F 236/06

(52) U.S. Cl. 118/264; 526/335

(57) ABSTRACT

[Issue] To provide an ink sponge and an inkpad employing the same, with which there is little deterioration or loss of ink.

[Means of Resolution] An ink sponge which comprises ethylene-propylene-diene rubber sponge. An inkpad comprising a base on which is provided an ink adhesion member for causing ink to adhere thereto, and a lid member, the ink adhesion member comprising ethylene-propylene-diene rubber sponge. The ethylene-propylene-diene rubber sponge can cause ink to adhere thereto but does not absorb the ink.

### TECHNICAL FIELD

The present invention relates to an ink sponge, an inkpad, and an inkpad set, and it relates in particular to an ink sponge which can cause ink to adhere thereto but does not absorb the ink, and to an inkpad employing the same.

### PRIOR ART

Inkpads are conventionally used for affixing rubber seals in a wide range of applications. The inkpads have an ink storage member for absorbing ink, which is provided on a base, and various shapes and sizes of inkpad are known in the art.

A material which absorbs ink is used for the ink storage member, and examples of materials which are used include felt, felt covered with a cloth or nonwoven fabric, and foamed resin sponge (see Patent Document 1). When a new inkpad is produced, the ink storage member is made to absorb sufficient ink on a single occasion so that it can be used for affixing ink over a long period.

### PRIOR ART DOCUMENT

### Patent Document

[Patent Document 1] Japanese Registered Utility Model 3006600

### SUMMARY OF THE INVENTION

### Issues to be Resolved by the Invention

The ink storage member in a conventional inkpad is formed from felt, felt covered with a cloth or nonwoven fabric, or foamed resin sponge, among other things, and therefore the ink can be properly absorbed and the inkpad can be used over a long period.

However, if the ink absorbed by the ink storage member is used over a long period of time, the ink concentration changes because of evaporation of the water and solvent in the ink, which produces deterioration of the ink. Furthermore, if the inkpad is not used for a long period, the ink often deteriorates or hardens, so there is a loss of ink.

There is thus a problem with conventional inkpads in which ink is absorbed by an ink storage member in that there is deterioration or loss of the ink.

The present invention has been devised in view of the prior art mentioned above, and it provides an ink sponge and an inkpad employing the same, with which there is little deterioration or loss of ink.

The present invention furthermore provides an inkpad set comprising the abovementioned inkpad with which there is little deterioration or loss of ink, and ink.

### Means of Resolving the Issues

The ink sponge for resolving the issues mentioned above comprises ethylene-propylene-diene rubber sponge.

The inkpad for resolving the above issues comprises a base on which is provided an ink adhesion member for causing ink to adhere thereto, and a lid member, the ink adhesion member comprising ethylene-propylene-diene rubber sponge.

The inkpad set for resolving the above issues comprises the abovementioned inkpad, and ink which has adhered to the ink adhesion member of said inkpad.

### Advantages of the Invention

The present invention makes it possible to provide an ink sponge and an inkpad employing the same, with which there is little deterioration or loss of ink.

The present invention furthermore makes it possible to provide an inkpad set comprising the above-mentioned inkpad with which there is little deterioration or loss of ink, and ink.

### BRIEF DESCRIPTION OF THE FIGURES

FIG. 1 is a schematic view in cross section showing one mode of embodiment of the inkpad according to the present invention.

### MODE OF EMBODIMENT OF THE INVENTION

A mode of embodiment of the present invention will be described below in detail.

The ink sponge according to the present invention comprises ethylene-propylene-diene rubber sponge.

The inkpad according to the present invention employs the abovementioned ink sponge. That is, the inkpad according to the present invention comprises a base on which is provided an ink adhesion member for causing ink to adhere thereto, and a lid member, the ink adhesion member comprising ethylene-propylene-diene rubber sponge.

The ethylene-propylene-diene rubber sponge which is used for the ink sponge or ink adhesion member according to the present invention is obtained by foam molding ethylene-propylene-diene rubber.

Ethylene-propylene-diene (EPDM) rubber is a rubber in which a small amount of a diene component, which is a third component, is introduced into ethylene and propylene, with a double bond being formed in the main chain. Ethylene-propylene-diene (EPDM) rubber is represented by the following structural formula (I), for example.

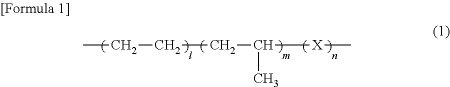

In the formula, X represents the diene third component, examples of which that may be mentioned including ethylidene norbornene (ENB), dicyclopentadiene (DCP), and 1,4-hexadiene (1,4-HD).

Ethylene-propylene-diene rubber has excellent weather resistance, heat resistance, water resistance, and solvent resistance.

Among others, an example of a commercially available ethylene-propylene-diene rubber sponge which may be mentioned is the product sold under the name Moran #531R by Bridgestone Corp.

### Exemplary Embodiment 1

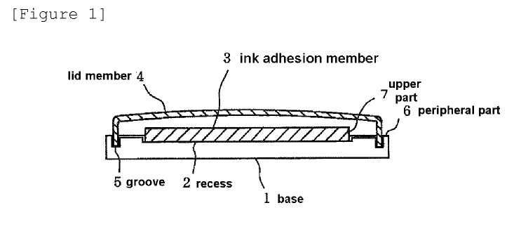

FIG. 1 is a schematic view in cross section showing one mode of embodiment of the inkpad according to the present invention.

As shown in FIG. 1, the inkpad according to the present invention comprises a base 1 on which is provided an ink adhesion member 3 for causing ink to adhere thereto, and a lid member 4. The ink adhesion member 3 comprises ethylene-propylene-diene rubber sponge, an upper part 7 of the ink adhesion member 3 projects from the base 1, and it is housed inside the base 1. Specifically, a recess 2 is provided in the base 1, and the ink adhesion member 3 is secured to the bottom surface of the recess 2 and housed in the recess in such a way that the upper part 7 of the ink adhesion member 3 projects from a peripheral part 6 of the base 1. The top part of the ink adhesion member 3 is covered by the lid member 4, and a groove 5 is cut into the peripheral part 6 of the base 1 so that a removable lid can be provided by fitting the tip end part at the periphery of the lid member 4 into said groove 5.

The example described in relation to FIG. 1 above concerns an inkpad in which the lid member is separate from the base and constitutes a different member, but the inkpad according to the present invention may have a structure in which the lid member and the base are joined by a hinge or a sheet made of a flexible material, or the like, in order to allow opening and closing.

The method of using the inkpad involves causing the adhesion of ink housed in an ink container to the ink adhesion member 3 at the time of use, because the ink adhesion member 3 does not contain ink before use, and then applying the ink which has adhered to the ink adhesion member 3 to a rubber seal for affixing.

The ethylene-propylene-diene rubber sponge of the ink adhesion member has closed cells, and therefore it can cause ink to adhere thereto but does not absorb the ink.

Furthermore, the ethylene-propylene-diene rubber sponge of the ink adhesion member has a high level of impact resilience and a soft, yielding texture, which therefore gives it a comfortable feeling when used with a rubber seal.

Meanwhile, the surface of the sponge is sliced, and therefore the cells remain as they are, so when ink is coated on the surface, the ink spreads without being absorbed, thereby forming a film-like structure comprising a certain thickness of ink. If a rubber seal is pressed into the sponge in this state, the fixed amount of ink adhering to the surface of the sponge is transferred to the rubber seal because the ink is not absorbed into the sponge. Furthermore, the sponge is well cushioned, so excess ink is not applied.

When a standard rubber seal is used with the inkpad according to the present invention, seals can be affixed 10-20 times after adhesion of ink from a single application.

Furthermore, with the ink sponge and inkpad employing the same according to the present invention, the sponge does not absorb the ink, and therefore the amount of ink consumed can be minimized, and there is little deterioration or loss of ink because the inkpad is always filled with fresh ink.

The ethylene-propylene-diene rubber sponge has good weather resistance, there is no deterioration of the sponge, and it also has good solvent resistance, and therefore this sponge can be used with any kind of ink, and inks employing dyes, pigments, water, or solvents may equally be used.

The inkpad set according to the present invention includes: an inkpad comprising a base on which is provided an ink adhesion member for causing ink to adhere thereto, and a lid member, the ink adhesion member comprising ethylene-propylene-diene rubber sponge; and ink which is adhered to the ink adhesion member housed inside a container.

One or two or more ink adhesion members may be provided in one inkpad. There may also be one or two or more types of ink. If there are two or more ink adhesion members, it is possible to use two or more types of ink in one inkpad.

### FIELD OF INDUSTRIAL APPLICATION

The inkpad according to the present invention can be utilized for providing ink stamps on paper, wood, plastic or human skin, etc.

### KEY TO SYMBOLS

1 base
2 recess
3 ink adhesion member
4 lid member
5 groove
6 peripheral part
7 upper part

1. An ink sponge which comprises ethylene-propylene-diene rubber sponge.

2. An inkpad comprising a base on which is provided an ink adhesion member for causing ink to adhere thereto, and a lid member, wherein the ink adhesion member comprises ethylene-propylene-diene rubber sponge.

3. The inkpad as claimed in claim 2, wherein the ethylene-propylene-diene rubber sponge can cause ink to adhere thereto but does not absorb the ink.

4. The inkpad as claimed in claim 2, wherein ink is caused to adhere to the ink adhesion member and the ink is applied to a rubber seal for affixing.

5. The inkpad as claimed in claim 2, and further comprising ink which has adhered to the ink adhesion member of said inkpad.
